(19) United States
(12) Patent Application Publication
(10) Pub. No.: US 2021/0199046 A1
(43) Pub. Date: Jul. 1, 2021

(54) Component Description of the Infinite Water Electrolysis Combustion Engine (I.W.E.C.E)

(71) Applicant: Markus James Meyers, Odessa, FL (US)

(72) Inventor: Markus James Meyers, Odessa, FL (US)

(21) Appl. No.: 16/602,938

(22) Filed: Dec. 27, 2019

(51) Int. Cl. F02B 43/10; F03G 7/10

(52) U.S. Cl. CPC F02B 43/10; F02B 2043/106; F03G 7/10

(57) ABSTRACT

The I.W.E.C.E. is a combustion engine designed to not need fuel. The electrolysis device splits molecules in this instance water or H2O into the atoms that make up the molecules. Then the atoms are used as fuel in place of traditional fuels. When the fuels are used or combusted, they will turn to steam and be moved to the cooling chamber where they will return to liquid state. The liquid water will then be separated into its components again, restarting the cycle. The system is separated into four main parts the “fuel” tank, the electrolysis chamber, the combustion chamber and the cooling chamber.

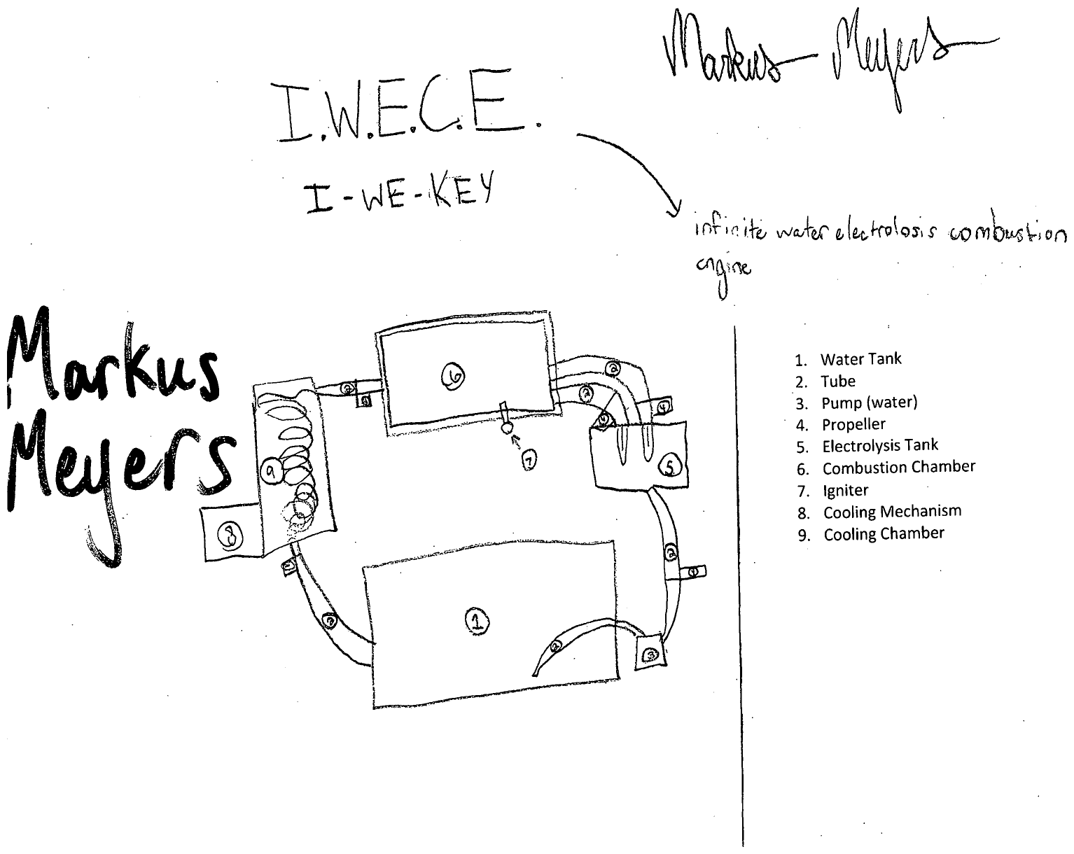

We will start off with a basic description of the I.W.E.C.E. At the bottom of the drawing and labeled “1” in the key there is a water holding chamber, this serves the purpose of holding water that is liquid and water that is not currently in the reaction process. Next the “tube,” labeled as “2.” The tube's purpose is for water in many forms (gas and liquid) throughout the reaction process to flow through the tubes. Also, it must be kept in mind that “tube” could easily be changed to the word “pipe” and would serve the same basic purpose. The next item are the pumps labeled “3” in the key. The pumps' purpose is to propel liquid water through the tubes. The items labeled as “4” in the key are propellers. These propellers propel H2O, whether it is in a gas or liquid state. The propellers may me employed for scenarios where the substance is either just gas or a mix of gas and liquid H2O that needs to be propelled through the tubes. Now for the electrolysis chamber which is labeled “5” in the key. This electrolysis chamber's basic purpose is to be the location in the engine where H2O will be split into its basic elements. The combustion chamber is labeled “6” on the key. This combustion chamber serves the purpose of containing the power of the fuel igniting and using it to create energy. The spark plug is next and is labeled “7” in the key. The spark plug's purpose is to ignite the fuel in the combustion chamber. Now for the air conditioning or cooling mechanism, which is labeled “8” in the key. The purpose of item “8” is to cool the substance surrounding the spiraling pipe in the cooling chamber. Keep in mind that this is subject to change. The final item listed is the cooling chamber labeled “9” in the key. The purpose of the cooling chamber is to allow water to flow through a spiraling pipe or tube. Outside of the pipe or tube is a substance that will be cooling the gas to a liquid for storage in the water tank.

Looking at the water tank (1) in the drawing, a tube (2) is attached to the right side of the water tank. This tube allows the water pump (3) to transport water to a propeller (4) inside the tube (2). The water continues into the electrolysis chamber (5). After the chemical reaction in the electrolysis chamber (5), water is split into hydrogen and oxygen. There are separate tubes (2) leading out of the chamber for each element. A propeller (4) is in each tube (2) to propel the elements through the tubes (2). These two tubes (2) lead to the combustion chamber (6). The igniter (7) is attached to the combustion chamber (6) and is used to initiate the combustion process. A tube (2) leads out of the combustion chamber (6) for the waste of the reaction. This tube also has a propeller (4) to transport the waste out of the chamber. This tube (2) leads to the cooling chamber (9). The tube (2) then leads down a spiral tube which is the cooling chamber (9). Attached to the cooling chamber (9) is the cooling mechanism (8). A tube (2) then leads out of the cooling chamber (9) and has a propeller (4) to propel the byproduct of the cooling chamber (9). This tube (2) then leads to the water chamber (1).

The basic principles of the invention will remain constant throughout this concept's lifetime. On the other hand, the components that make up the concept will be subject to modification and optimization.

### BRIEF DESCRIPTION OF THE DRAWING

It is an engine divided into four main sections. The sections are bridged by tubes. The tubes have pumps and propellers to transport water in gas or liquid form through them. The main sections are the water tank (1), the electrolysis chamber (5), combustion chamber (6) and a cooling chamber (9).

1. Combusting hydrogen atoms, cooling the resulting water molecules, splitting the water molecules with electricity for the purpose of combusting the hydrogen atoms again in a sealed system.
An absolutely zero exhaust combustion engine based on water electrolysis.
A combustion engine that does not require to be re-fueled.
